(19) United States
(12) Patent Application Publication
(10) Pub. No.: US 2016/0212978 A1
(43) Pub. Date: Jul. 28, 2016

(54) SYSTEM AND METHOD FOR IN SITU SETTLEMENT AND RECRUITMENT OF SHELLFISH AND DEVELOPING REEF

(71) Applicants: Paul Chandler Matthews, III, Mattituck, NY (US); Peter Elliot Danforth, Port Jefferson Station, NY (US)

(72) Inventors: Paul Chandler Matthews, III, Mattituck, NY (US); Peter Elliot Danforth, Port Jefferson Station, NY (US)

(21) Appl. No.: 15/024,803

(22) PCT Filed: Sep. 25, 2014
(86) PCT No.: PCT/US14/57349

§ 371 Date: Mar. 24, 2016

Related U.S. Application Data
(60) Provisional application No. 61/882,921, filed on Sep. 26, 2013.

(51) Int. Cl. A01K 61/00

(52) U.S. Cl. CPC A01K 61/002

(57) ABSTRACT

A shellfish trap system and a method for developing a reef are provided. The shellfish trap system includes a growing assembly, a first protective layer, and a second protective layer. The growing assembly includes a material which is conducive for shellfish in the pediveliger larvae stage to attach to. The first protective layer substantially envelops at least a first portion of the growing assembly during a first developmental stage of the shellfish and is removed from the growing assembly after completion of the first developmental stage. The second protective layer substantially envelops at least a second portion of the growing assembly during a second developmental stage of the shellfish, wherein the at least a second portion of the growing assembly is submerged in water during the second developmental stage of the shellfish.

The present invention relates to a system and method for developing a reef, and, more particularly, to a system and method for receiving shellfish in the veliger stage in a shellfish set trap system at the site of a reef, providing variable levels of protection, and incorporating the system into the reef.

### BACKGROUND

Shellfish and their reefs, both declining in number, provide a large variety of benefits to the marine ecosystem and the human population. In addition to providing a primary and nutritious food source to many cultures since the dawn of mankind, shellfish, and especially oyster reefs, provide a filtration system that removes excess nutrients from the water and create potable water systems. This filtration includes the removal of nitrates that lead to harmful algal blooms and polluted sediments. Other advantages include providing a buffer against storm surge, mitigating waves, and reducing coastal erosion. Reefs further provide the benefit of promoting diverse marine habitats.

The once thriving business of harvesting wild shellfish is partially responsible for the decimation of many estuaries, bays, and inlets. Despite attempts at reseeding and leasing of oyster beds, there has still been a collapse of certain shellfish populations. Other factors contributing to the decline in reefs and the shellfish population include overfishing, pollution from the rise of cities, diseases afflicting shellfish, and predation due to ecosystem imbalances.

Efforts to redevelop oyster reefs in areas where oyster larvae are lacking include depositing cultch and larvae on the floor of a body of water. The deposited larvae are already attached to the cultch. However, these newly set shellfish are unprotected and prone to suffocation by the cultch and silt. This can be exacerbated by waves that cause the larvae to scatter and disturb the silt, increasing the risk of suffocation.

Therefore, a sustainable, effective way to increase shellfish populations is needed. Moreover, an effective way to build shellfish reefs in areas that are deficient or could benefit from the positive effects of shellfish habitation is sought after.

### SUMMARY

These and other purposes, goals and advantages of the present application will become apparent from the following detailed description read in connection with the accompanying drawings.

The present disclosure provides a shellfish set trap system (SSTS) for developing a reef. The SSTS includes a growing assembly, a first protective layer, and a second protective layer. The growing assembly includes a material which is conducive for shellfish in the pediveliger larvae stage to attach to. The first protective layer substantially envelops at least a first portion of the growing assembly during a first developmental stage of the shellfish and is removed from the growing assembly after completion of the first developmental stage. The second protective layer substantially envelops at least a second portion of the growing assembly during a second developmental stage of the shellfish, wherein the enveloped portion of the growing assembly is submerged in water during the second developmental stage of the shellfish.

In one embodiment, the first protective layer is a removable nonpermeable layer that provides a barrier between larvae provided in the growing assembly and the ambient environment, and the second protective layer is a permeable layer. In another embodiment, the second protective layer is removable. In still another embodiment, the second protective layer is provided with a temporary coupling so that the second protective layer will break along the temporary coupling in response to application of pressure to the second protective layer.

The second protective layer can have a plurality of apertures sized to protect shellfish attached to the growing assembly from substantial predation during the second developmental stage. In one embodiment, the first protective layer forms a vessel that can hold a liquid, and the growing assembly is inserted into the vessel, wherein the growing assembly is disposed in the vessel during the first developmental stage and the first protective layer is removed by removing the growing assembly from the vessel.

In one embodiment, the pediveliger larvae are introduced into the growing assembly before the growing assembly is inserted in the vessel. The growing assembly can include an aperture that is positioned substantially above the water via which the pediveliger larvae can be introduced into the growing assembly.

The first protective layer can be wrapped around the growing assembly before it is inserted into the vessel. The second protective layer can be wrapped around the growing assembly after the first protective layer is removed.

In an embodiment of the growing assembly, the growing assembly includes at least one permeable structure and a plurality of growing elements mounted to the permeable structure(s). One or more of the permeable structures can be a receptacle. The receptacle can be a fish trap, and the remainder of the growing assembly can be retrofitted to the fish trap.

In an embodiment, the growing assembly is expandable in at least one dimension after the first or second protective layers are removed. In another embodiment, the permanent structure(s) are provided with at least two surfaces upon which the growing elements are mounted, wherein the surfaces are movable relative to one other. In one embodiment, the growing assembly can be flexed into a first shape while enveloped by the first or second protective layers, and the growing assembly can be flexed into a second shape after the first and second protective layers are removed.

The permeable structure(s) can have multiple surfaces, and the plurality of growing elements can be distributed on at least one of the multiple surfaces. In one embodiment, the plurality of growing elements are attached to the permeable structure(s) with epoxy or with a securing device.

In another embodiment, the permeable structure(s) of the growing assembly include a first and second permeable structure, and the plurality of growing elements are positioned between the first and second permeable structures in order to mount the plurality of growing elements between the first and second permeable structures. At least one of the first and second permeable structures can be formed of mesh.

In an embodiment, a modular reef is formed by combining a first and second module, the first module including the growing assembly after the first protective layer is removed, and the second module including a second growing assembly of a second shellfish set trap system after its first protective layer is removed. The first and second modules can be coupled to one another.

In an embodiment, the shellfish set trap system is provided with a flotation device that is attached to the growing assembly. In another an embodiment, the shellfish set trap system is provided with an anchor that is coupled to the growing assembly. Alternatively, the shellfish set trap system can be positioned on a pedestal that is positioned on the floor of a body of water.

A method for developing a reef is provided. The method includes enveloping a growing assembly with a first protective layer and enveloping the growing assembly with a second protective layer. The growing assembly includes a material which is favorable for shellfish in the pediveliger larvae stage to attach to.

The first protective layer includes a nonpermeable layer that substantially envelops at least a first portion of the growing assembly during a first developmental stage of the shellfish so that the first protective layer provides a barrier between the first portion of the growing assembly and its ambient environment. The second protective layer substantially envelops at least a second portion of the growing assembly during a second developmental stage of the shellfish, wherein the second protective layer is a permeable layer.

The method further includes introducing a plurality of shellfish in the pediveliger larvae stage and filtered water into the growing assembly, subsequent to enveloping the growing assembly with the first protective layer. The growing assembly is deployed in situ, wherein at least the second portion of the growing assembly is submerged in water during at least the second developmental stage of the shellfish. The method includes waiting a first time interval until the completion of the first developmental stage of the shellfish. Subsequent to waiting the first time interval, the protective layer(s) are removed.

In an embodiment of the method, enveloping the growing assembly with the first protective layer includes forming a vessel that the growing assembly is disposed within. Another embodiment of the method includes waiting a second time interval until the completion of the second developmental stage, and subsequent to waiting the second time interval, removing the second protective layer.

The method can further include assembling the growing assembly, including securing a plurality of growing elements to at least one permeable structure of the growing assembly. In an embodiment, the permeable structure(s) include a first and second permeable structure, and securing the plurality of growing elements includes positioning the plurality of growing elements in between the first and second permeable structures.

In one embodiment, the permeable structure(s) includes multiple surfaces, and securing the plurality of growing elements comprises distributing the plurality of growing elements on at least one of the multiple surfaces.

The method can further include configuring the growing assembly in a first shape during the first and second stages of development while the growing assembly is enveloped by either of the first and second protective layers, and configuring the growing assembly in a second shape after the first and second protective layers are removed.

In one embodiment, introducing the plurality of larvae into the vessel includes exposing the growing assembly to the plurality of larvae and then inserting the growing assembly into the vessel. In another embodiment, introducing the plurality of larvae into the vessel includes providing the plurality of larvae and filtered water into the vessel while the growing assembly is disposed in the vessel.

In one embodiment, enveloping the growing assembly with the second protective layer is performed before enveloping the growing assembly with the first protective layer. In another embodiment, enveloping the growing assembly with the second protective layer is performed after enveloping the growing assembly with the first protective layer, and after the first protective layer is removed.

In still another embodiment, the method further includes combining a first and second module, the first module including the growing assembly after the protective layer(s) are removed, and the second module including a second growing assembly after its protective layer(s) are removed. Combining the growing assembly and the other growing assembly can include coupling them to one another.

In an embodiment, deploying the growing assembly in situ can include attaching a flotation device to the shellfish set trap system. In another embodiment, deploying the growing assembly in situ includes positioning the growing assembly on a pedestal that is positioned on the floor of a body of water.

### BRIEF DESCRIPTION OF THE DRAWINGS

Some embodiments or aspects of the disclosure are illustrated by way of example and not limitation in the figures of the accompanying drawings in which:

FIG. 1 illustrates a shellfish set trap system (SSTS) in accordance with the present disclosure;

FIG. 2 illustrates a growing assembly of the SSTS shown in FIG. 1;

FIG. 3 shows another embodiment of the growing assembly shown in FIG. 2;

FIG. 4 shows a modular reef formed of a plurality of the SSTS's shown in FIG. 1;

FIG. 5A shows another embodiment of an SSTS in a partially assembled configuration, in accordance with the present disclosure;

FIG. 5B shows the SSTS shown in FIG. 5A in an assembled configuration;

FIG. 5C shows another embodiment of the growing assembly that is included in the SSTS shown in FIG. 5A;

FIG. 5D shows another embodiment of the growing assembly in an open configuration, in accordance with the present disclosure;

FIG. 5E shows the growing assembly shown in FIG. 5D in a closed configuration;

FIG. 5F shows an example folder page of the growing assembly shown in FIG. 5D;

FIG. 6 is a modular reef formed of a plurality of SSTS's shown in FIG. 5A; and

FIG. 7 shows a series of layers that form the SSTS shown in FIG. 1 or 5A.

### DETAILED DESCRIPTION

The following sections describe exemplary embodiments of the present disclosure. It should be apparent to those skilled in the art that the described embodiments of the present disclosure provided herein are illustrative only and not limiting, having been presented by way of example only. All features disclosed in this description may be replaced by alternative features serving the same or similar purpose, unless expressly stated otherwise. Therefore, numerous other embodiments of the modifications thereof are contemplated as falling within the scope of the present disclosure as defined herein and equivalents thereto.

The present disclosure is directed to a shellfish set trap system (SSTS) configured to receive shellfish when they are in the pediveliger stage and form a reef. The SSTS provides protection at varying selectable levels, provides a setting environment that is incorporated into the reef, and develops the reef.

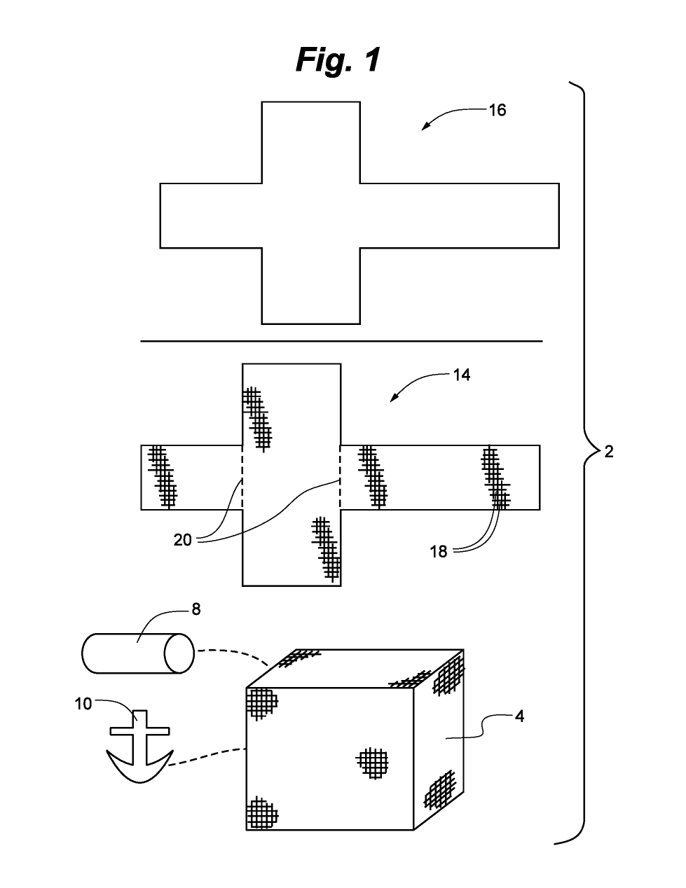

Referring to FIG. 1, an exemplary shellfish set trap system (SSTS) according to the present disclosure is shown generally as SSTS 2. The SSTS 2 includes a growing assembly 4 and at least one removable protective layer 6. Shellfish at the pediveliger larvae stage are introduced into the SSTS 2 and attach themselves to at least one surface of the growing assembly 4 and remain there to mature into adults as well as through the adult phase of their lives. The SSTS 2 can further include a flotation device 8 and an anchor 10 that can be used if the SSTS 2 is deployed in deep water to float the SSTS 2 and anchor it to control its position.

The term “shellfish,” as used herein, is not intended to be limiting to any particular species of fish, but refers to fish that have a larval stage of development during which the shellfish larvae attach themselves to a growing substrate and continue to mature to while attached. The growing substrate can be part of an established or developing reef. Examples of shellfish include oysters, mussels, clams, scallops, bivalves, barnacles, and crustaceans. An established or developing reef can include one or more colonies of one or more types of shellfish. A preferred shellfish is oyster.

The term “pediveliger larvae,” as used herein, refers to the last larval stage of shellfish in which the shellfish is developmentally ready to, and/or seeks to, attach to a growing substrate. The pediveliger larvae are referred to herein as larvae or shellfish larvae.

The term “competent to set,” as used herein, describes a shellfish when it is in its last larval stage and is developmentally ready to attach to a growing substrate and/or seeks to attach to the growing substrate.

The term “attach,” as used herein, refers to the process of settlement of larvae in which they adhere or attach themselves to an appropriate surface where they remain until a next stage of their development, or, for some species, such as oysters, for the remainder of their life.

The growing assembly 4 includes a material that is conducive for the shellfish larvae to attach to. Conducive, as used herein, refers to tending to promote or facilitate. A material that is conducive for the shellfish larvae to attach to promotes or facilitates such attachment by being attractive to the shellfish larvae for attaching to and does not repel them. The material is not toxic to the shellfish and does not harm their health when they are larvae, as they mature, or become adults. The material has a texture such that the shellfish larvae can successfully attach to the material and remain there with a substantial success rate. Examples of the material include cultch, which can include shells or shell fragments, and manmade materials that mimic or approximate cultch, such as calcium carbonate.

The protective layer(s) 6 include a removable, permeable protective layer 14 and/or a removable, nonpermeable protective layer 16. During deployment, the growing assembly 4 is partially or completely submerged in water, and the protective layer(s) 6 substantially envelop the submerged portion of the growing assembly 4 during at least one developmental stage of the shellfish. The protective layer(s) are 6 removed from the growing assembly 4, or vice versa, after completion of the developmental stage(s).

Submerging the growing assembly 4 in water can include floating and anchoring the growing assembly 4 in a body of water, placing it in shallow or deep water, placing it on the bottom (e.g., floor, sea floor, bay bottom) of the body of water, securing it to a stable structure (e.g., a boat or a dock), or placing it on an object (e.g., dock, rock or pedestal) that is floating beneath the surface of the body of water or standing on the bottom of the body of water.

Enveloping the growing assembly 4 includes enveloping at least a portion of the growing assembly 4, which can include wrapping the protective layer(s) 6 around the growing assembly 4, or forming a vessel having a cavity that the growing assembly 4 is disposed within so that the vessel contains the growing assembly 4. The protective layer(s) are removable by unwrapping it from the growing assembly 4 or removing the growing assembly 4 from within the cavity of the vessel.

The water within which the growing assembly 4 is submerged can be at a target reef location, in situ, or at an offsite location. The term “in situ,” as used herein, refers to the target reef location where the reef will be established or proximate to it and in the same body of water. In situ can also refer to an outdoor environment, in the same body of water or a different body of water as the target reef location, that has substantially the same physical characteristics that make up the habitat of the target reef location. Examples of physical factors that are substantially the same include temperature range and patterns, availability of light, availability of food, predator presence, water quality, water salinity level, mineral content in water, etc. The in situ location can be a manmade or naturally formed fresh body of water or salt body of water, such as a pond, lake, river, or ocean.

The term “target location,” as used herein, refers to the location in which the reef is intended to be established once the shellfish have matured into adults. The term “established,” as used herein, refers to remaining in the location permanently or long term. An indication that an established reef is thriving is when an ecosystem develops within and/or along the reef. The ecosystem can include plant growth and the presence of other fish and animals, such as for hiding, feeding, mating, or hunting. An established reef can become part of such an ecosystem and/or the ecosystem can develop because of the presence of the reef.

An offsite location can include an environment that is substantially different than the target reef location, and can be natural or manmade, including a manmade pool or tub that is land borne or is situated on a boat.

The developmental stage(s) include one or more developmental stages, such as, but not limited to, an attachment stage and a recruitment stage. The term “attachment stage,” as used herein, refers to a stage during which the shellfish larvae fasten themselves to the growing assembly 4. The attachment stage for oysters lasts about 36-48 hours, commencing when the larvae are introduced into the SSTS 2, and completed when a majority of the shellfish larvae introduced into the SSTS 2 have attached (e.g., fastened) themselves. The duration of the developmental stage can be different for other species. The term “attachment,” as used herein refers to the process of attaching to the growing assembly 4. The term “settlement” is used interchangeably with “attachment,” and the terms “attach” and “set” can be used interchangeably.

The term “recruitment stage,” as used herein, refers to a stage during which the attached shellfish mature to adults, which for oysters is approximately 2-4 months. The duration of the recruitment stage can be different for other species. “Recruitment,” as used herein, refers to the development that occurs during the recruitment stage.

When the shellfish larvae are first introduced into the SSTS 2, a portion, or all, of the growing assembly 4 can be submerged in water. At least the submerged portion of the growing assembly 4 is substantially enveloped by the protective layer(s). In an embodiment in which both the permeable and nonpermeable protective layers 14, 16 are used, the growing assembly 4 is enveloped in the permeable protective layer 14, and the growing assembly 4 and permeable protective layer 14 are enveloped in the nonpermeable protective layer 16. The nonpermeable protective layer 16 is removed after a first time interval. The permeable protective layer 14 can optionally be removed afterwards, such as after a second time interval. The first time interval corresponds to the duration of the attachment stage. The second time interval corresponds to the duration of the recruitment stage.

In another embodiment, the growing assembly 4 is enveloped in the nonpermeable protective layer 16 and then removed therefrom after the first time interval, as described further below. Then the growing assembly 4 is enveloped in the permeable protective layer 14, after which it too, optionally, can be removed therefrom, e.g., after the second time interval, as described further below.

Alternatively, only one of the nonpermeable protective layer 16 and permeable protective layer 14 envelopes the growing assembly 4. In the case that the nonpermeable protective layer 16 is used to envelop the growing assembly, it is then removed after the first time interval. In the case that the permeable protective layer 14 is used to envelope the growing assembly, it can optionally be removed, e.g., after the second time interval. The SSTS 2 can be deployed in situ before the shellfish larvae are introduced into the SSTS 2, after the larvae are introduced into the SSTS 2, during the attachment stage, during the recruitment stage, or after the recruitment stage. It can be advantageous to deploy the SSTS 2 in situ at an earlier stage of the development of the shellfish in order that the shellfish begin early to acclimate to the in situ environment in order to increase survivability rates and hardiness of the shellfish. Even when the shellfish are in filtered water in a closed environment surrounded by the nonpermeable layer 16, deployment in situ allows the shellfish to acclimate to aspects of the environment, such as motion and temperature of the water.

Experimentation performed using the SSTS 2 has resulted in an unexpected discovery that shellfish need their environment to have warmer temperatures in order to spawn than they do in order to set. The term “spawn,” as used herein refers to the reproductive action of a release of eggs or sperm by a mature oyster. Experimental results studying oysters, clams, and scallops, have shown that a threshold temperature needed for setting is about 10° C. less than a threshold temperature needed for spawning. For example, in some species, the spawning threshold temperature is about 25° C., whereas the setting threshold temperature is about 15° C. In this example, the average environmental temperature must reach the threshold temperature before the respective spawning or setting will occur. The threshold temperature is not limited to these examples, and can be determined based parameters other than average temperature, such as an equation that compares high and low temperatures.

When human intervention is not involved, along the northeast coast of New York, the spawning season generally begins in June. Setting of the shellfish will not occur until the spawned shellfish are competent to set. However, by the time the shellfish are competent to set, predators have reached a stage of maturity, upon which they are ready to prey upon the young shellfish.

The shellfish spawning season terminates when the average environmental temperatures fall below the spawning threshold temperature. Setting terminates after the last shellfish to spawn have set, even if the average temperature is still above the threshold setting temperature.

When using the SSTS 2 and the method of the present disclosure, the shellfish can be spawned in an environment having controlled temperatures, such as a laboratory, at any season of the year. The shellfish can be introduced into an SSTS 2 that has been deployed in situ or at a target site once average temperatures have reached the threshold setting temperature, which generally occurs in May (4-6 weeks before the natural spawning season begins) along the northeast coast of NY, and lasts until temperatures fall below the threshold setting temperature (about 4-6 weeks after spawning season ends). Accordingly, the season during which the shellfish can spawn and set in situ is extended, approximately by over a month at the beginning of the season, and nearly a month at the end of the season.

In addition to the extended periods during which the shellfish can set in situ, the risks posed by predators are reduced. During the extended period before the natural season, shellfish predators have not yet matured to a stage in which they can prey upon the shellfish. Additionally, during the extended period after the natural season, many shellfish predators hibernate or die, decreasing the amount of predators that can prey upon the shellfish. Thus the shellfish can avoid predation during the extended periods before and after the natural season during which shellfish set.

Additionally, the attached shellfish can survive in temperatures that are below the spawning threshold temperature and the setting threshold temperature. Accordingly, when both spawning and setting are performed in temperature controlled laboratory environments, the season for recruitment and development of the reef can be even further extended before and after the natural seasons for spawning and recruitment.

The permeable protective layer 14 is provided with a plurality of apertures 18 so that it is permeable to water, plants, animals, and other objects in the water that are smaller than the apertures 18. The apertures 18 are sized to filter the water without becoming clogged, and to protect the attached young shellfish from substantial predation, especially during the recruitment stage. Substantial predation can include rampant predation, which refers to unchecked predation. Substantial predation can also refer to predation that decimates a substantial portion of the shellfish colony, which includes the population of shellfish that are attached to the growing assembly 4. The size of apertures 18 is thus selected to avoid clogging of the apertures 18, the saturation of the shellfish colony (e.g., how well populated the colony is), and the type and quantity of predators in the ambient environment. The term ambient environment, as used herein, refers to the surrounding environment.

For oyster reef development in the northeast portion of the United States, apertures 18 are preferably sized 2 mm-4 mm, with other ranges envisioned, including 2 mm-5 mm or 1.5 mm-6 mm. The disclosure is not limited to the above stated ranges, as different sizes may be used for other species of shellfish, for use in other environments, for different colonization conditions, and for different predation conditions.

The permeable layer 14 is formed of a permeable material, such as a mesh or netting, or a sheet or board having a plurality of small apertures 18 formed therein. The term “mesh,” as referred to herein, refers to a network of wire, thread, cord, metal links, or the like, defining openings (also referred to herein as apertures) therebetween. The material forming the permeable protective layer 14 can be rigid or non-rigid. It can include more than one portion, e.g., panels that can be tied, clamped, hinged, or otherwise coupled to one another. Examples of rigid materials include: metal, glass, rigid plastic, wood, bamboo, etc. Examples of non-rigid materials include: cloth, flexible plastic, rope, flexible wire, flexible metal, reed, a flexible or rigid material having joints or hinges or that is foldable, etc.

The permeable protective layer 14 can be formed as a vessel or sack into which the growing assembly 4 is placed, or the permeable protective layer 14 can be wrapped around the growing assembly 4 and secured with securing devices, such as duct tape, string, rope, clips, twistable wire, etc., or bonded, such as by applying heat or an epoxy. The permeable layer 14 can be shaped and/or cut to enable easy wrapping of the growing assembly 4.

The permeable protective layer 14 can optionally be provided with one or more strategically positioned temporary couplings 20. The temporary coupling 20 can be included with a wall of the permeable protective layer 14, for example, as one or more scored lines, grooves, partial incisions, aligned perforations, or the like. Alternatively, or additionally, the temporary couplings 20 can couple two portions, e.g., walls or panels, of the permeable protective layer 14, such as chains, clasps, or tethers. As the shellfish colony attached to the growing assembly 4 grows, it may increase in size and exert pressure on the permeable protective layer 14 so that the temporary coupling 20 will fail, e.g., break or open, and two portions of the permeable protective layer 14 that were coupled by one or more of the temporary couplings 20 will separate from one another. Such growth may be due to the individual shellfish growing in size as they mature, or an increase in population due to reproduction of the original colony of shellfish or larvae that were spawned in the ambient environment by other shellfish.

When the permeable protective layer 14 separates along one or more temporary couplings 20, it is fully or partially removed from the growing assembly 4. The broken-away permeable protective layer 14 can fall to the floor of the body of water, or can remain attached to the growing assembly 4, such as by a rope or wire tether, so that it can be collected and disposed of at a convenient time.

The nonpermeable layer 16 is nonpermeable so that water, plants, animals, and other objects in the water cannot enter the SSTS 2. Thus, the nonpermeable layer 16 acts as a barrier between the ambient environment and the growing assembly 4, including its contents, e.g., the larvae introduced into the growing assembly. This separation protects the pediveliger larvae from all predators that are outside of the enclosure formed by the nonpermeable layer 16.

The nonpermeable layer 16 is formed of a substantially nonpermeable material so that water, plants, animals, and other objects in the water cannot enter the SSTS 2. The nonpermeable material can be rigid or non-rigid. It can include more than one portion, e.g., panels, which can be tied, clamped, hinged, or otherwise coupled to one another. Examples of rigid materials include: metal, glass, rigid plastic, wood, etc. Examples of non-rigid materials include: flexible plastic, flexible metal, a flexible or rigid material having joints or hinges or that is foldable, etc.

The nonpermeable layer 16 may be formed as a vessel, such as a sack or barrel, into which the growing assembly 4 is placed, or the nonpermeable layer 16 can be wrapped around the growing assembly 4 and secured with securing devices, such as duct tape, string, rope, clips, twistable wire, etc., or bonded, such as by applying heat or an epoxy. The nonpermeable layer 16 can be shaped and/or cut to enable easy wrapping of the growing assembly 4.

The materials forming the nonpermeable layer 16 and the permeable protective layer 14 are safe for shellfish at their various stages of development, do not repel the shellfish, can withstand the environment in which they are deployed, and are not toxic to the environment. They do not contain zinc, which can be toxic to shellfish.

The protective layer(s) envelop the growing assembly 4 to enclose the portion of the growing assembly 4 that becomes submerged in water when the growing assembly 4 is deployed, e.g., in situ or in another environment in which protection is warranted. When the SSTS 2 is configured to be entirely submerged during deployment, the protective layer(s) enclose substantially the entire growing assembly 4. When the SSTS 2 is configured to float, a top surface of the growing assembly 4 can be totally or partially exposed to the ambient air and not be enclosed by the protective layer(s). It is possible that unfiltered ambient water may enter the SSTS 2 and reach the growing assembly 4 via the open portion of the top surface, particularly when the water has waves or during rough weather. Entry of a relatively small amount of ambient water into the SSTS 2 can act favorably to promote development of a safe habitat and ecosystem within the SSTS 2.

The nonpermeable layer 16 is the outermost layer of the SSTS 2 before its removal. The nonpermeable layer 16 is removed after the first time interval. Since the first time interval corresponds to the duration of the attachment stage, the recommended duration for the first interval may vary depending on the species of shellfish. For oysters, the first time interval is approximately 36-48 hours from introduction of the larvae to the growing assembly 4. If the first time interval extends beyond the recommended duration, it can be helpful to aerate the enveloped growing assembly 4. If the first time interval is shorter than the recommended duration, the shellfish may not have set yet, and their chances of successfully setting can decrease.

After the nonpermeable layer 16 is removed, the growing assembly 4 can be covered by the permeable protective layer 14. The permeable protective layer 14 may have been already wrapped around the growing assembly 4, or it can be wrapped around the growing assembly 4 after the nonpermeable layer 16 is removed.

During the recruitment stage, while the permeable protective layer 14 is wrapped around the growing assembly 4, the growing assembly 4 can develop as a natural habitat having an ecosystem. Plants and animals that are smaller than the diameter of the apertures 18 can enter and exit the growing assembly 4, while larger predators that are capable of substantial predation are substantially blocked from entering.

The permeable protective layer 14 can be removed after the second time interval. Since the second time interval corresponds to the duration of the recruitment stage, the recommended duration for the second interval may vary depending on the species of shellfish. For oysters, the second time interval is approximately 2-4 months. There are situations in which the permeable protective layer 14 can be retained for a longer interval of time and/or not removed from the SSTS 2, or allowed to break off on its own along temporary coupling 20.

The permeable protective layer 14 and/or nonpermeable protective layer 16 can provide a substrate that frames and protects the shellfish from perils existing in the body of water where they are deployed. The perils, in addition to predators, can include waves and silt that can suffocate the shellfish. This protection can be critical for newly set shellfish during the first time interval, as well as for more mature shellfish during and after the second interval.

Once the second time interval is completed, the growing assembly 4 can continue to develop. The growing assembly 4 can be deployed next to and/or attached to other growing assemblies 4 in a modular fashion to form a reef. The deployment can be in an environment that is the same as, or similar to, the environment in which the growing assembly 4 was located before this deployment. Since the shellfish have become acclimated to their environment, deployment in the same environment is less traumatic to the shellfish and more likely to succeed.

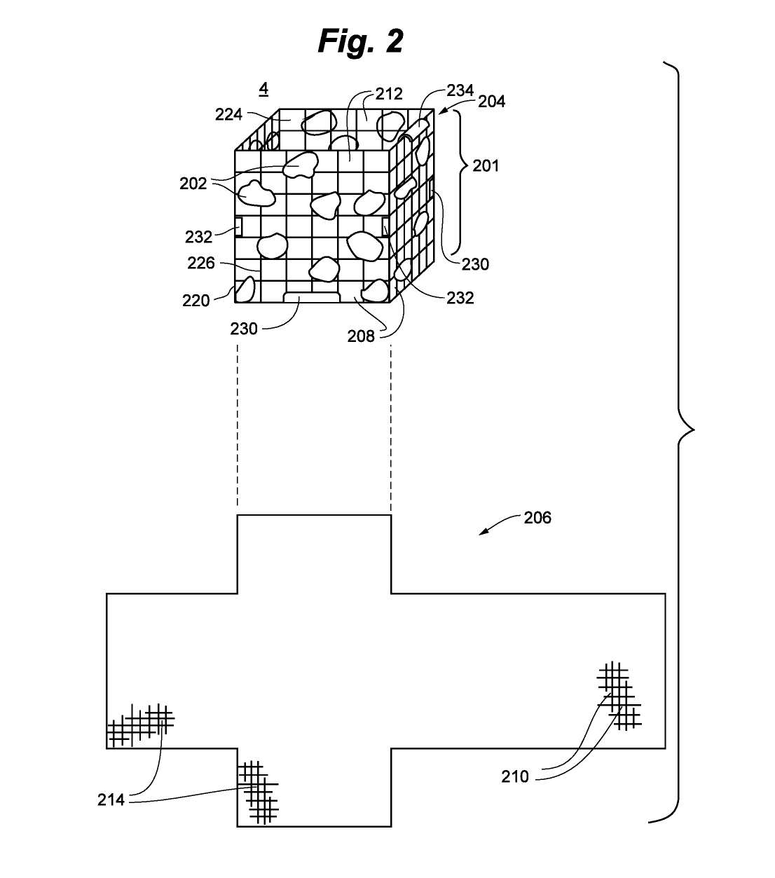

With reference to FIG. 2, an example growing assembly 4 is shown having a growing substrate 201 that is mounted to the first and/or second structures 204, 206 by positioning the growing substrate 201 therebetween. The growing substrate 201 can be held in position by adhering it to at least one of the first and second structures 204, 206, or by application of pressure on the growing substrate 201 by at least one of the first and second structures 204, 206. The shellfish can attach themselves to the growing substrate 201 and, while attached, develop into adult shellfish.

The growing substrate 201 can include a plurality of growing elements 202 that are mounted to and distributed about one or more surfaces of the first and/or second structures 204, 206. The growing substrate 201 and growing elements 202 are formed of a material that is conducive for shellfish at the pediveliger stage to attach to during the settlement or attachment phase of their life. Materials that are conducive for attachment by shellfish include, naturally formed materials, such as cultch, and/or manmade materials that can form or coat the growing elements 202.

Examples of cultch include shells from shellfish, which can be whole shells or shell fragments, oyster shells, clam shells, mussel shells, shallot shells, etc. The cultch can be conditioned to increase its conduciveness for larvae to attach to, such as by removing unwanted material, e.g., flesh and bacteria. The manmade material, e.g., calcium carbonate, can be conditioned, such as by removing, e.g., leeching out, any toxic materials, so that toxic materials will not interfere with the attachment process or growth of the shellfish once they are attached. A toxic material herein refers to a material that interferes with the development or survivability of the shellfish, which can include repelling them or discouraging them from attaching to a surface having the material or near the material.

The drawings are not intended to indicate the density of the growing elements 202 when they are distributed on the surface(s) of the first and/or second structures 204, 206. The growing elements 202 can be more or less numerous, or densely distributed, than shown in the drawings. The growing elements 202 can overlap one another, and can be evenly or unevenly distributed.

In the example shown, the growing assembly 4 is assembled by securing the first structure 204 and a second structure 206 together with the growing elements 202 positioned in between. The second structure 206 covers at least a portion of the first structure 204, including portions upon which the shellfish are attached. Additionally, the second structure 206 can provide a permeable barrier between the first structure 204 and the ambient environment. The second structure 206 can be removable from the first structure 204, such as at a later stage of development, or can be permanently secured to the first structure 204.

The first structure 204 and second structure 206 can be secured together, for example, by tying them together, e.g., with rope or wire, by wrapping one layer around the other, and/or by nesting them. The rope or wire may be wrapped around the first structure 204 and second structure 206 to secure them together. Additionally or alternatively, one or both of the first structure 204 and second structure 206 can have structures, such as apertures (including apertures 208, 210), loops, or hooks, through which a rope or wire can be introduced for securing the first structure 204 and second structure 206 to one another. One or more coupling devices, such as a clasp, clamp, clip, or duct tape, can be used to secure first structure 204 and second structure 206 together.

The growing elements 202 can be mounted to one or both of the first and second structures 204 and 206, such as by using an epoxy or fastening them with a securing device, such as duct tape, string, rope, a clip, twistable wire, etc. Alternatively or additionally, the first and second structures 204 and 206 can exert pressure on the growing elements 202 to secure them in their respective positions between the first and second structures 204 and 206, so that they are mounted to at least one of the first and second structures 204, 206.

In an embodiment, the growing substrate 201 includes the plurality of growing elements 202 configured so that they are attached to one another, such as to form a network. The growing elements 202 can be attached to each other, for example, by a textile, plastic, or wire filament, or network of filaments, e.g., a mesh. In one such embodiment, the growing substrate 201 includes the growing elements 202 and a substrate formed of a porous textile material, such as gauze, that the growing elements are attached to.

In another embodiment, the growing substrate 201 is integrated with a permeable material of the SSTS 2, such as the permeable structure 204 and/or 206 or with the permeable protective layer 14 by applying the growing material to the permeable material with a growing material, such as to coat one or more surfaces of the permeable material. The growing material is a material, such as calcium carbonate, that is conducive for the larvae to attach to during the recruitment stage. The growing material can be applied as a liquid, foam, paste, clay, or gel, to the permeable material, such as by spraying, painting, molding, or laminating the permeable material with the growing material, or dipping the permeable material into a the growing material. The liquid, foam, or gel growing material can harden on the permeable material to form a permeable wall that includes the growing substrate 201. The growing assembly 4 can be eliminated, or alternatively, the growing elements 202 can be substituted with the growing material.

In another embodiment, the growing assembly 4 can include a solid wall to which the growing material is applied, instead of including the growing elements 202. The solid wall can include, for example, sheetrock, drywall, plasterboard, and/or layers of gypsum and heavy paper, etc. to which the growing material can be applied.

The first structure 204 has at least one wall 212, and the second structure 206 has at least one wall 214. Walls 212, 214 are formed of permeable materials that have a plurality of apertures 208, 210, respectively. Apertures 208, 210 are sized so that walls 212, 214 hold or assist in holding the growing elements 202 in place, and are small enough so that the growing elements 202 will not fall through. Apertures 208, 210 are also sized to be large enough to allow permeation, into and out of the SSTS 2, of water and small living or inanimate objects, without clogging the apertures 208, 210.

A secondary function of the protective structures 204, 206 is to help protect the attached shellfish from predators, particularly after the permeable protective layer 114 is removed. The size of apertures 208, 210 can be larger than apertures 18, because apertures 208, 210 are sized to provide protection after the termination of the second time interval, when the shellfish are already adults, whereas apertures 18 are sized to prevent penetration of predators during the second time interval.

By allowing a flow of water through first structure 204 and second structure 206, the growing assembly 4 is exposed to the natural environment while protected from substantial predation. This allows an ecosystem, which can be a microcosm of the habitat, to develop in closed areas of the growing assembly 4, thus encouraging development of a reef.

Apertures 208, 210 are preferably sized 2 mm-4 mm, with other ranges envisioned, including 2 mm-5 mm or 1.5 mm-6 mm. The disclosure is not limited to the above stated ranges, as different sizes may be used for other species of shellfish, for use in other environments, for different colonization conditions, and for different predation conditions.

The first structure 204 and second structure 206 can be formed of the same or different permeable materials. Examples of permeable materials include a mesh, lattice, lace, network, sheet or board having the apertures 208 and/or 210 formed therein, etc. The permeable material can be rigid or flexible. It can include more than one portion or panel that can be tied, clamped, hinged, or otherwise coupled to one another. Examples of rigid materials include: metal, glass, rigid plastic, wood, bamboo, etc. Examples of non-rigid materials include: cloth, flexible plastic, rope, cord, string, reed, fabric, flexible wire, flexible sheet metal, a flexible or rigid material having joints or hinges or that is otherwise foldable or collapsible, etc.

The materials forming the first structure 204, second structure 206, the growing elements 202, epoxies or securing devices that are used to secure the growing elements 202 to the first and/or structures 204, 206, and epoxies or securing devices that are used to secure the first and second structure 204 to one another are safe for shellfish at their various stages of development, do not repel the shellfish, can withstand the environment and manner in which they are deployed, and are not toxic to the environment. For example, when the SSTS 2 is designed for deployment in a saltwater environment, all materials used must be resistant to corrosion from salt water. If the SSTS 2 includes components formed of metal and is configured to float, it may need to have a coating that protects it from rusting.

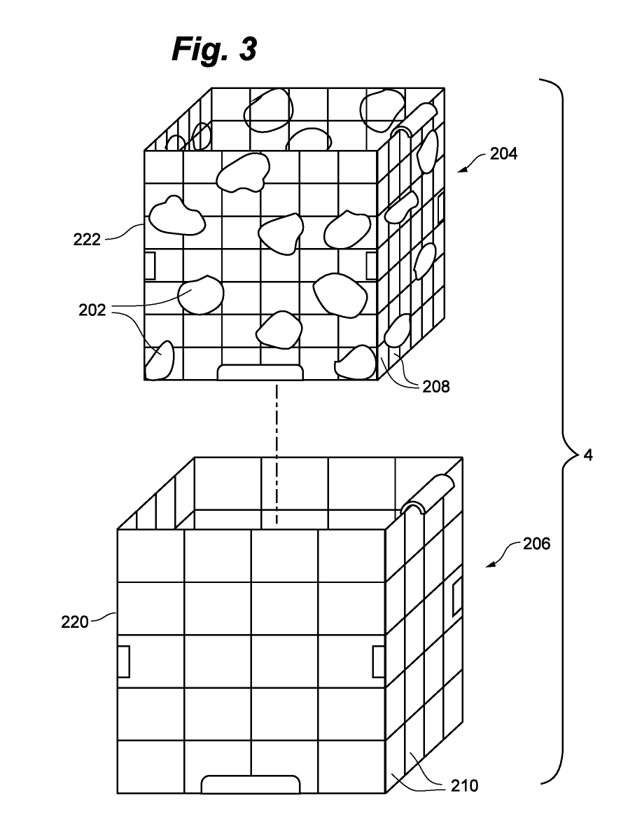

The walls 212 of first structure 204 can be flat or curved, can be positioned at an angle relative to one another, and can further form a receptacle 220. Similarly, walls 214 of second structure 206 can be flat or curved, can be positioned at an angle relative to one another, and can further form a receptacle 222 (as shown in FIG. 3). The receptacles 220 and 222 can be formed in a variety of shapes. In the example shown in FIGS. 2 and 3, the receptacles 220 and 222 are formed as rectangular cuboids with an open top face 224. Alternatively, top face 224 can be closed. In other embodiments, the receptacles 220 or 222 can be triangular, cylindrical, pyramidal, conical, etc.

In the example shown in FIG. 2, the cuboid receptacle 220 has five walls 212 formed of a rigid wire lattice. The top face 224 is open. Growing elements 202 are provided on an outer surface 226 of the walls 212, and can be dispersed about each of the walls 212 in a random or organized fashion.

The second structure 206 is a sheet of wire mesh, such as chicken wire. The sheet of mesh forming second structure 206 is shaped, sized, and/or cut to wrap around the receptacle 220. The growing elements 202 can be attached to the outer surface of the walls 212 or to the inner surface of walls 214 before the second structure 206 is wrapped around the receptacle 220. Alternatively, the growing elements 202 can be placed or slipped in between the receptacle 220 and the second structure 206 before or after the second structure 206 is wrapped around the receptacle 220. The growing elements 202 are held in place therebetween by the inner surface of walls 214 pressing against the outer surface of walls 212. Additionally, the walls 212 and 214 can be provided with protrusions (not shown), such as hooks, nubs, ridges, barbs, which help to hold the growing elements 202 in distributed positions. The second structure 206 is wrapped around the receptacle 220 and secured in place. The second structure 206 can be wrapped so as to cover the top face 224 or leave it uncovered.

The receptacle 220 can be a conventional fish trap used to catch fish or shellfish, e.g., an eel, lobster, fish, oyster, or crab trap. The receptacle 220 can have a door or wall 212 that opens and closes, hinges 230 that a wall 212 or door can pivot about, and/or a latch 232 that facilitates opening and closing a door or wall 212. The trap can be retrofitted by wrapping the second structure 206 around the trap, with growing elements 202 positioned between the trap and the second structure 206, thus forming a growing assembly 4 of an SSTS 2. The term “retrofit,” as used herein, refers to providing an apparatus that was already manufactured, such as a trap, with new or modified parts, such as the growing elements 202 and the protective layer(s).

In an embodiment, the growing elements 202 are securely attached to the first structure 204, and first and second structures 204, 206 are movable relative to each other. The first and second structures 204, 206 can also be removable from one another after the protective layer(s) are removed.

Additionally, in an embodiment, the first and/or second structures 204, 206 can be configured so that receptacles 220 and/or 222 can change shape. The first structure 204 can be formed of a flexible material. In another example, the first structure 204 can be provided with position adjustment means, such as a hinge, track, or groove, for moving one or more of the walls 212 relative to the other walls 212, such as for moving, sliding, or articulating the wall(s) 212 between a first position (e.g., a closed configuration) and a second position (e.g., an open configuration). Additionally, the first structure 204 can be provided with locking means, such as a clasp or lock 232, that is configured to selectively prevent or allow movement of the wall(s) 212. The second structure 206 can be provided with similar features, e.g., using a flexible material, movement adjustment means, and/or a locking means.

With reference to FIG. 3, an embodiment is shown in which the first structure 204 is nested inside the second structure 206, or vice versa. The growing elements 202 are positioned between the first and second nested structures 204 and 206. The first and second structures 204, 206 can be tightly nested so that pressure is exerted on growing elements 202 to stabilize them for maintaining them in distributed positions on the outer surface of walls 212. Additionally or alternatively, the growing elements 202 can be attached to the outer surface of walls 212 or the inner surface of walls 214.

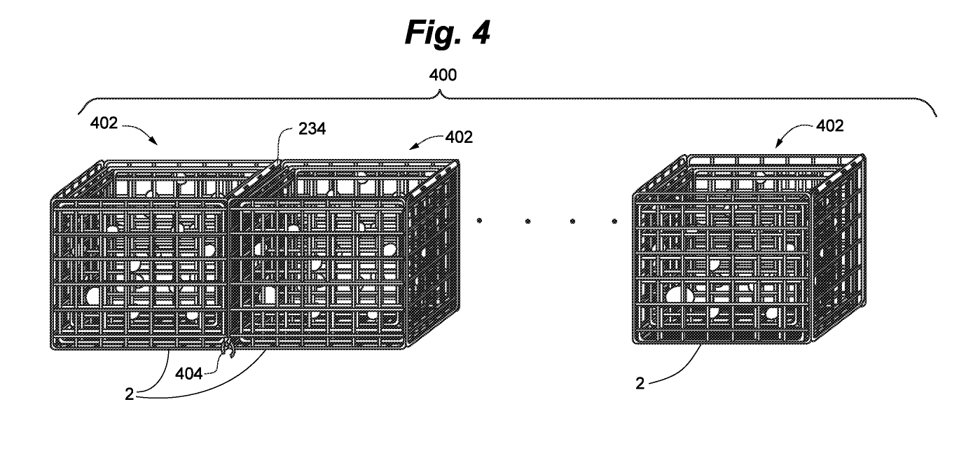

With reference to FIG. 4, exemplary modular reef system 400 is shown. A plurality of SSTS's 2, with the protective layer(s) removed, are deployed by positioning them adjacent to one another at the target reef location, with each SSTS 2 configured as a module 402 of the modular reef 400. The modules 402 can be physically coupled to one another with a coupling device, such as a tether 404 (e.g., a rope, cord, bungee cord, hook, clasp, etc.) or clamp 234. Alternatively, the modules 402 can be physically located adjacent to one another without coupling them to one another, either spaced from one another or in physical contact.

The modules 402 can be positioned together and/or coupled together at various stages of the shellfish's development for forming modular reef system 400. The different developmental stages include, for example, before the larvae are introduced into the SSTS's 2, or as pre-set modules after the larvae have already attached themselves to the growing assembly 4.

The modules 402 can be integrated into modular reef system 400 either before or after the permeable protective layer 14 and/or nonpermeable layer 16 have been removed.

The deployed modules 402 can be floated and anchored, placed on the floor of the body of water, secured to a stable structure (e.g., a boat or a dock), or placed on a pedestal that stands on the floor of the body of water of the target reef location. When floated, the anchors can be effectively removed (e.g., lifted and placed in a boat) from the modules 402 so that the modules 402 can be relocated to a new location. Relocation can be helpful to remove the modules 402 before the onset of an event that is expected to pose a risk to the modules 402, such as a storm or a harmful algal bloom. Relocation can also be helpful for establishing a new reef system 400 in a new location using all or some of modules 402 of an existing reef system 400.

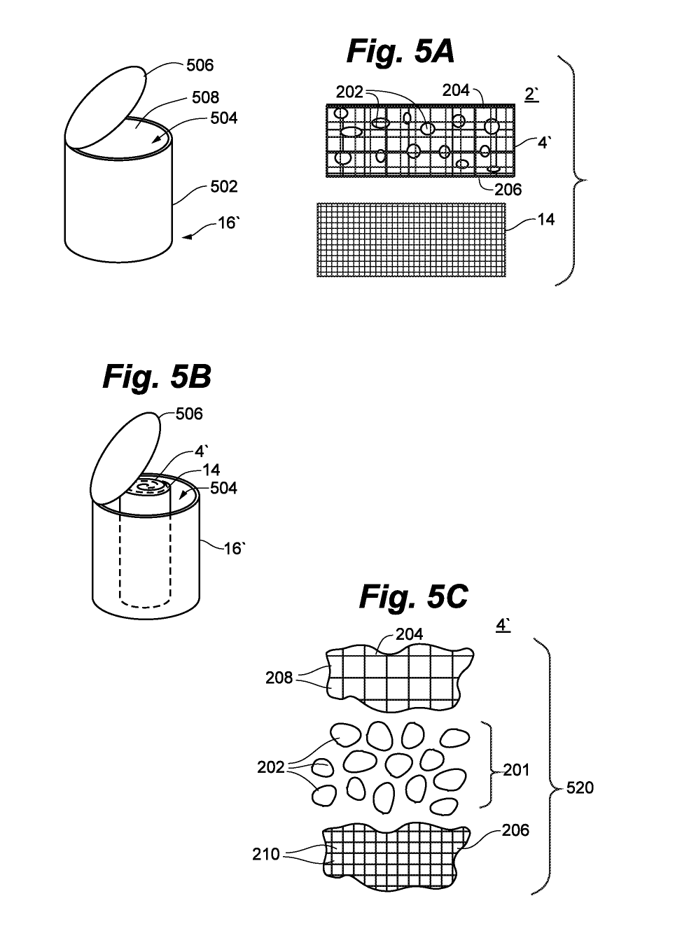

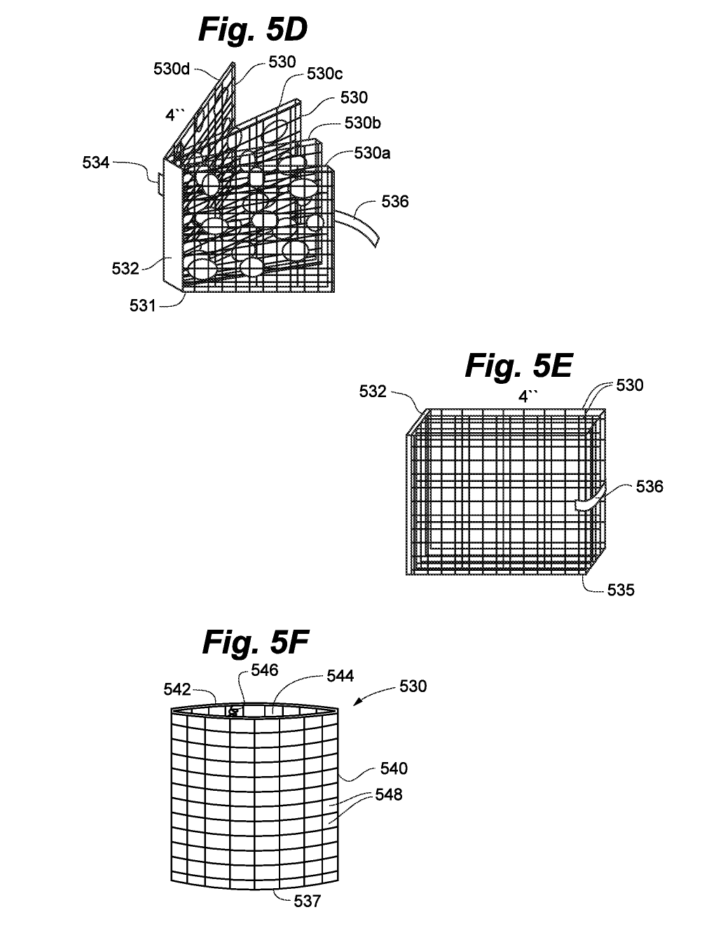

With reference to FIGS. 5A and 5B, another example embodiment is shown of an SSTS 2′ in an unassembled and assembled state, respectively. A nonpermeable layer 16′ is configured as a receptacle 502. In the example shown in FIG. 5A, the receptacle 502 is shaped as a rigid cylinder, such as a barrel, with an interior cavity 504. Optionally, the receptacle 502 can be provided with a lid 506 that can open or close. Alternatively, the receptacle 502 can be lidless with an open mouth 508.

A flexible growing assembly 4′ is a provided that can be flexed, e.g., rolled, folded (e.g., accordion style), or crumpled. Permeable protective layer 14 is a flexible layer that can be wrapped around the growing assembly 4′. Alternatively, permeable protective layer 14 can be formed as a flexible or rigid sack that can fit inside receptacle 502.

As shown in FIG. 5B, the assembled growing assembly 4′ is rolled and wrapped in permeable protective layer 14 and inserted in the cavity 504 formed in receptacle 502. Alternatively growing assembly 4′ is inserted into receptacle 502 without the permeable layer 14, and after the growing assembly 4′ is removed from the receptacle 502, it is wrapped in the permeable protective layer 14.

FIG. 5C shows an example configuration of layers 520 that form growing assembly 4′. Growing substrate 201, including a plurality of growing elements 202, is positioned between first and second structures 204 and 206. The growing assembly 4 is assembled by layering the first and second structures 204, 206, with the growing elements 202 positioned therebetween. First and second structures 204 and 206 are both formed of a flexible, permeable material, e.g., wire mesh that can be flexed. First and second structures 204 and 206 can be compressed, e.g., rolled or folded, when enveloped by the protective layer(s). First and second structures 204 and 206 can be expanded, e.g., unrolled or unfolded to form a wall, when the protective layer(s) are removed.

With reference to FIGS. 5D-5F, another embodiment of growing assembly 4″ is shown. Growing assembly 4″ includes multiple permeable folder pages 530 that are secured at their proximate edges 531 by a binding 532 that allows the folder pages 530 to move relative to one another. The growing assembly 4″ is shown in FIG. 5D in an open configuration, and in FIG. 5E in a closed configuration. One or more locking mechanisms can be provided to maintain the growing assembly 4″ in the open or closed configuration, based on which configuration is selected. The binding 532 can be provided with one or more locking mechanisms 534 that can hold the folder pages 530 in an open position in which they fan out, such as the open configuration shown in FIG. 5D, and/or in a closed position, such as the closed configuration shown in FIG. 5E. Alternatively or additionally, a locking mechanism 536 can be coupled to a distal edge 535 of the outer folder pages 530A, D that can hold the pages in a closed position.

The locking mechanisms 534 and 536 can be operated manually or in reaction to force applied by the shellfish as they grow in size individually, and/or in population. For example, the locking mechanisms 534 and/or 536 can be provided with a temporary coupling that breaks when pressure is applied, for fully or partially unlocking the locking mechanism 534 and/or 536. Additionally, the locking mechanisms 534 and/or 536 can be configured to maintain the position of the folder pages 530 relative to one another, such as for allowing the positions of the folder pages 530 to change in an incremental fashion.

As shown in FIG. 5F, each folder page 503 has two permeable layers 540 and 542 that are attached at their proximate edge 531, distal edge 535, and a bottom edge 537, forming a pocket having cavity 544 that is accessible from its top. The growing elements 202 can be inserted into the pocket through its top. The layers 540 and 542 can be sufficiently taut so that they squeeze against the inserted growing elements 202 to keep them in distributed positions within the pocket. The layers 540 and 542 can further have protrusions (not shown), such as hooks, nubs, ridges, barbs, that help to hold the growing elements 202 in distributed positions.

The folder pages 503 can further be provided with one or more resilient members 546 that are each attached at opposing ends to layers 540 and 542, respectively. The resilient members 546 bias the layers 540 and 542 so that they squeeze against each other for closing the cavity 544 of the pocket and holding the inserted growing elements 202 in distributed positions. The resilient members 546 can be stretched by applying a force to allow a separation of layers 540 and 542 and an opening of the cavity 544 of the pocket for insertion of the growing elements 502 and/or growth of attached shellfish into the cavity 544. Examples of resilient members include springs, rubber bands, and elastic bands.

Alternatively, the folder pages 530 can be formed of a single layer that the growing elements 202 are secured to with epoxy or a securing device, such as duct tape, string, rope, clips, or twistable wire. Growing elements 202 can be secured to a single surface or opposing surfaces of the single layer.

The layers of the folder pages 530 are formed of a permeable material, such as mesh or netting, or a sheet or board of a material having a plurality of small apertures 548 formed therein. Apertures 548 are sized to keep, or assist in keeping, the growing elements 202 in place, and are small enough so that the growing elements 202 will not fall through the apertures 548. Apertures 548 are also sized to be large enough to allow permeation, into and out of the SSTS 2, of water and small living or inanimate objects, without clogging the apertures 548. Secondarily, the apertures 548 can be sized to help protect the attached shellfish from predators, particularly after the permeable protective layer 114 is removed.

In accordance with the embodiment shown in FIGS. 5D-5F, the growing elements 202 can be dispersed on many surfaces of the growing assembly 4″, e.g., on the surfaces of folder pages 530, e.g., on the surfaces of layers 540 and 542. As conditions become crowded, such as due to growth of the shellfish and/or expansion of the population of shellfish attaching to the growing assembly 4″, the growing assembly 4″ can be opened from a closed configuration to an open configuration, as well as in incremental amounts. Accordingly, the growing assembly 4″ can be adjusted to open or close the folder pages 530 relative to one another as needed, such as for providing the shellfish with more room and aeration as they grow in size and population. The growing assembly 4″ can be oriented in any direction, such as with the binder 532 facing in an upward or downward position or towards either side.

In the embodiments shown in FIGS. 2, 3, and 5A-F, the first and second structures 204 and 206, receptacle 502, and/or folder pages 530 can provide a substrate that frames and protects the shellfish from perils existing in the body of water where they are deployed. The perils, in addition to predators, can include waves and silt that can suffocate the shellfish. This protection can be critical for newly set shellfish during the first time interval, as well as for more mature shellfish during and after the second interval.

The configurations of growing assembly 4, 4′, 4″ shown in FIGS. 2, 3, and 5A-5F are provided as examples and are not intended to be limiting. As shown in the various embodiments, the growing assembly 4, 4′, 4″ can have multiple surfaces about which growing elements 202 can be distributed.

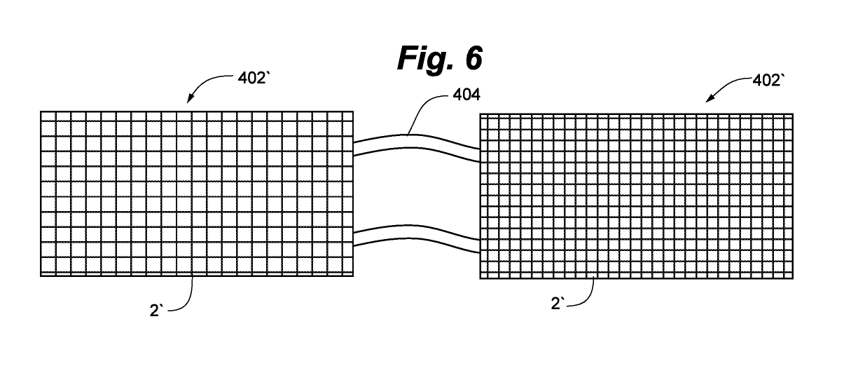

With reference to FIG. 6, another example embodiment of a modular reef 400′ is shown. A plurality of SSTS's 2′ are positioned adjacent one another in a body of water of the target reef location, with each SSTS 2′ configured as a module 402′ of the modular reef 400′. As shown, the protective layer(s) have been removed and the growing assembly 4′ has been flexed (e.g., unrolled) to an expanded state. In an example of the expanded state, the growing assembly 4′'s dimensions are approximately 3′×8′, without limitation thereto.

The expanded modules 402′ can be physically coupled to one another with a coupling device, such as a tether 404 (e.g., a rope, cord, bungee cord, hook, clasp, etc.) or clamp 206. Alternatively, the modules 402′ can be physically located adjacent to one another without coupling them to one another, either spaced from one another or in physical contact. The deployed modules 402′ can be floated and anchored, placed on the floor of the body of water, secured to a stable structure (e.g., a boat or a dock) or placed on a pedestal that stands on the floor of the body of water. The modules 402′ can be positioned together and/or coupled together for forming modular reef 400′ at various stages of the shellfish's development, e.g., before the larvae are introduced into the SSTS's 2′, or as pre-set modules after the larvae have already attached themselves to the growing assembly 4′, either before or after the permeable protective layer 14 and/or non-permeable protective layer 26 have been removed.

The configurations of SSTS 2 and SSTS 2′ are not limited to the configurations shown in FIGS. 1-6. For example, in an embodiment (not shown), the growing assembly 4 includes a flexible substrate, such as a thick rope, onto which the plurality of growing elements 202 have been secured, e.g., with securing devices such as string, staples, twistable wire ties, etc. In this embodiment, the first and second structures 204 and 206 can be omitted. The growing assembly 4 is wrapped in the protective layer(s), which are removed, one layer at a time, as described above.

In still another embodiment, the growing assembly 4 includes the plurality of growing elements 202 securely attached to the first structure 204, and does not include the second structure 206. The second structure 206 is not needed to stabilize the plurality of growing elements 202, as the growing elements are securely attached and stabilized to the first structure 204. In this embodiment, the plurality of growing elements 202 are exposed to unfiltered ambient water after the first and second protective layers are removed, without protection, e.g., from second structure 206. In this example, the in situ environment is sufficiently free from the threat of substantial predation to adult shellfish.

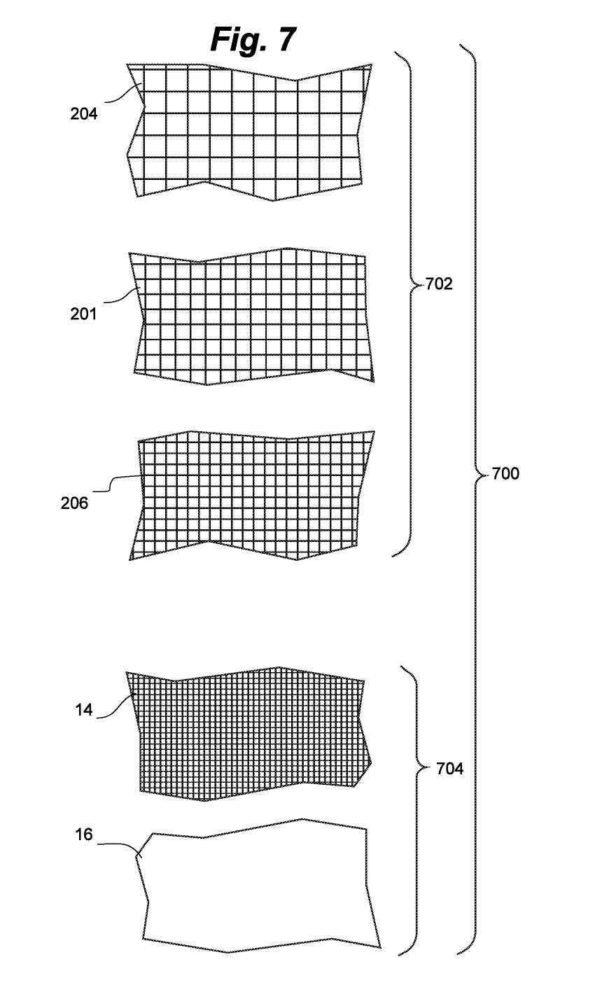

With reference to FIG. 7, an example series of layers 700 is shown that are included in SSTS 2. The first set of layers 702 includes the layers of the growing assembly 4. The second set of layers 704 includes the protective layer(s), including the protective layers 14 and 16 that envelop the growing assembly 4. The protective layers 14 and 16 can envelop the growing assembly 4 either successively, one at a time, or simultaneously (e.g., with non-permeable protective layer 14 wrapped around permeable protective layer 16), until they are removed in a staggered fashion, one at a time.

FIG. 7 shows the layers sequenced in an example order, with the innermost layer shown as structure 204 and the outermost layer shown as nonpermeable protective layer 16. The sequenced order of protective structures 204 and 206 can be reversed. As described with reference to FIG. 2, the wall(s) of both of the protective structures 204 and 206 can be rigid, flexible, or a combination thereof. In another example configuration, the layers 704 for the growing assembly 4 can be replaced with the layers 520 shown in FIG. 5C for growing assembly 4′.

In an example method of assembling an example SSTS 2 and nurturing its development, the growing assembly 4 is assembled by attaching the growing elements 202 to at least one of the first or second structures 204, 206 and coupling the first and second structures 204, 206 together, e.g., by tying them together with rope or twistable wire, wrapping one around the other, and/or inserting one inside the other in a nested fashion. Alternatively, the first and second structures 204, 206 can be coupled together, after which the growing elements 202 are inserted between them so that they are held in place.

In an embodiment, the growing assembly 4 is assembled by securely attaching the growing substrate 201 to one of the first and second structures 204, 206, and the other of the first and second structures 204, 206 is not used.

When the growing assembly 4 is configured as a receptacle, a top face or a portion thereof can be open. Alternatively, it can be covered.

The growing assembly 4 is then enveloped by the permeable protective layer 14 and then the nonpermeable protective layer 16. Alternatively, the growing assembly 4 is enveloped in only the nonpermeable protective layer 16 at this stage.

Enveloping the growing assembly 4 in the nonpermeable protective layer 16 can include wrapping the nonpermeable protective layer about at least a first portion of the growing assembly 4 so that liquid cannot penetrate the wrapped portion. The nonpermeable protective layer 16 can be a heavy layer of thick plastic. The wrapping process can be similar to applying shrink wrap, such as by applying heat to melt the plastic to seal the plastic to itself or to the growing assembly 4 so that at least a portion of the growing assembly 4 is protected from water penetration. In another example, enveloping the growing assembly 4 includes placing the growing assembly 4 inside a receptacle, such as a sack or a barrel, formed by the nonpermeable protective layer 16.

The enveloping process can include leaving an aperture via which the larvae can be introduced. The aperture can be closed and/or sealed after the larvae are introduced, or it can be left open.

Once enveloped in nonpermeable protective layer 16, SSTS 2 can be deployed in a body of water, which can be in situ, or at an offsite location, such as a manmade pool that is land borne or is situated on a boat. Alternatively, the SSTS 2 can be deployed in a body of water after the nonpermeable protective layer 16 is removed, while enveloped in the permeable protective layer 14.

Deploying the SSTS 2 can include floating and anchoring the SSTS 2, such as by coupling it to a floating device and an anchor, placing it in shallow water, or submerging it. When submerged, the nonpermeable protective layer 16 is hermetically sealed all about the SSTS 2. When floated or a placed in shallow water, the nonpermeable protective layer 16 protects the portion of the SSTS 2 that is submerged in the water from entry of ambient water. If the top surface is open to the air, it is sufficiently raised above the water to prevent the entry of a substantial amount of ambient water. The top surface can be provided with a cover that can be permeable or nonpermeable.

When placing the SSTS 2 in shallow water, it can be raised in the water column (which extends from the floor of the body of water to the surface of the water) off the floor of the body of water, such as by placing it on a rock, cement block, box, steel frame, wire legs, etc. By raising the SSTS 2 off the floor, it is raised above silt that can exist on the floor, thus avoiding the possibility of the silt suffocating the shellfish at the various stages of their development were the SSTS 2 to sink into the silt and/or the silt to be churned by movement of the water.

Filtered water and the larvae are introduced, e.g., poured in, through an aperture in the nonpermeable protective layer 16, e.g., through the open top surface. The aperture can be shaped for facilitating receipt of the filtered water and larvae. The larvae should be introduced before they develop a pigmented eye spot (upon which they can be referred to as “eyed”), since development of the eye spot is an indication that the larvae are competent to set. The eyed larvae remain competent to set for a relatively small window of time. If the larvae are introduced after that window of time has passed, they will not set in the growing assembly 4. Development of the larvae can be slowed by chilling them, which can delay the larvae becoming eyed.

Because the nonpermeable protective layer 16 forms a vessel that holds liquid, the introduced filtered water and larvae are retained inside the SSTS 2. The growing assembly 4 situated inside the vessel is exposed to the larvae. Even if the growing assembly 4 is configured as a receptacle, e.g., receptacle 220, the receptacle is permeable and the larvae can access the growing assembly 4.

The filtered water can be from any source. There are advantages to using water that is from the habitat that the SSTS 2 will be deployed in when the nonpermeable protective layer 16 is removed, since the shellfish can begin to acclimate to the water while they are still larvae, increasing their chance of survival and their robustness. The water is filtered so as to remove most potential predators. In the current example, the water is filtered using a 40 or 50 micron filter.

The filtered water can be introduced before or together with the larvae. A large volume of reconstituted larvae can be provided, allowing for a high concentration of larvae within the filtered water. For example, approximately five million larvae can be delivered via a reconstituted portion that is approximately the size of a golf ball.

When introducing the larvae, an example range of concentration is 10,000 to 20,000 larvae per cubic foot of water. The concentration can be increased when there is an expected increase in harshness of survival conditions during the first or second time intervals, or thereafter. Examples of increased harshness of survival conditions include inclement weather, introduction late, early, or outside of the ideal season for setting, and heavy predation.

If the growing assembly 4 has not yet been wrapped in the nonpermeable protective layer 16, it is wrapped after the larvae have been received in the SSTS 2. The nonpermeable protective layer 16 is wrapped around at least a second portion of the growing assembly 4. The first and second portions can be the same or different from one another. If the growing assembly 4 has not yet been deployed in a body of water, which can be in situ or offsite, it is now deployed. Deployment is not critical at this stage, since the larvae are contained in a closed environment. However, deployment can be helpful for acclimation of the larvae to the temperature and motion of the ambient water. The larvae need little, if any care. Aeration of the SSTS 2 is optional.

After waiting for a first time interval, the nonpermeable protective layer 16 is removed from the growing assembly 4. Waiting for too short a time interval can result in exposing the larvae at too earlier a stage of their life to a threat of predation that they are vulnerable to, and may further disturb their process of attachment. Waiting for too long may deprive the attached shellfish from nutrients and the opportunity to acclimate to the ambient environment. Waiting the most preferred time interval is most likely to result in robust attachment and high survivability rates of the shellfish, which for oysters is approximately 36-48 hours, as described above.

It may be of little consequence if a small amount of ambient water enters the SSTS 2 during the first time interval, such as due to waves entering via the aperture, e.g., when waters that the SSTS 2 is deployed in become choppy due to rough weather. There is not a large concern if the entry of small amount of water incurs a small amount of predation. The main concern is to prevent substantial predation.

After the first time interval, the nonpermeable protective layer 16 is removed, e.g., by unwrapping the nonpermeable protective layer 16, or removing the growing assembly 4 from a receptacle formed by the nonpermeable protective layer 16.

If the growing assembly 4 is not wrapped in the permeable protective layer 14, it is now wrapped. If the growing assembly 4 is not yet deployed offsite or in situ, it is now deployed offsite or in situ.

The SSTS 2 is allowed to develop as a reef during the second time interval. The SSTS 2 does not need any special care during this time interval. The second time interval can extend until the attached shellfish mature to adults, which for oysters is preferably approximately 2-4 months, as described above. Waiting for too short a time interval can result in exposing the shellfish to a threat of predation that they are vulnerable to at too earlier a stage of their life. Waiting for too long, in some situations, may deprive beneficial creatures access to the reef for developing the reef and its ecosystem, and may delay development of the reef.

During the second time interval, the SSTS 2 is developing into a reef, with the SSTS 2 becoming an integral part of the developing reef. An ecosystem develops within the area bounded by the permeable protective layer 14, by filtering out most predators, but allowing some organisms, such as small fish and plants, to enter. Small fish that enter can hide within and continue to grow inside the SSTS 2, and even may become trapped within. The SSTS 2 provides a closed but permeable configuration that can be a haven that attracts organisms to enter and hide, thus developing a unique habitat within. In actual experimentation, when the permeable protective layer 14 was removed after the second time interval had terminated, the SSTS 2 was found with fish and other organisms thriving inside and developing in the reef.

After completion of the second time interval, the permeable protective layer 14 is removed from the growing assembly 4, or vice versa. If not yet deployed in situ, the SSTS 2 can now be deployed in situ.

For deployment, the growing assembly 4 can be expanded into an enlarged configuration. Expanding the growing assembly 4 can include opening a door, or swinging or sliding one or more walls 212 relative to one another, such as to open the receptacle and enlarge the dimensions of the SSTS 2.

The SSTS 2, before or after it is already partially developed as a reef, can be combined with other SSTS's 2 to form a modular reef 400 (See FIG. 4). Thus each SSTS 2 is a module 402 that can be combined with other modules 402 to form a reef 400. Combining modules 402 together can include relocating the SSTS 2 modules 402, if necessary, coupling the SSTS 2 modules 402 to one another, and/or stabilizing their position, e.g., by floating and anchoring them, submerging them, or placing them on the floor or a pedestal standing on the floor of the body of water.

A second example method is provided for assembling the SSTS 2′ and developing reef 400′. Method steps that are the same as described above with reference to SSTS 2 are not repeated for purposes of brevity. In this example, the growing assembly 4′ is assembled in accordance with the description of FIGS. 5A-5C. Growing assembly 4′ is provided directly with larvae, such as by dipping the growing assembly 4′ into a tank of larvae mixed with filtered water so that they stick to the growing assembly 4′ and thus impregnate it.

The impregnated growing assembly 4′ is flexed, e.g., rolled, or folded (such as, accordion style), into a compressed configuration, such as a roll, and is then enveloped by, e.g., inserted within, the nonpermeable protective layer 16. Filtered water may be added within a receptacle formed by the nonpermeable protective layer 16 so that the larvae are immersed in a predator free water environment in order to attach themselves to the growing assembly 4′. The larvae can be added into the receptacle together with, or after, the filtered water, instead of, or in addition to, dipping the growing assembly 4′ into the larvae mixture.

At the end of the first time interval, the growing assembly 4′ is removed from within the nonpermeable protective layer 16, or vice versa. If not yet wrapped in the permeable protective layer 14 or deployed in situ or offsite, it is now wrapped and deployed. The compressed or rolled up configuration can be loosened so that while it is wrapped in the permeable protective layer 14 and deployed, there exist crevices and hiding places within the SSTS 2′ for small fish and organisms can inhabit, hide in, and/or grow therein. In this way, an ecosystem can begin to develop within the developing reef.

After the second time interval, the permeable protective layer 14 is removed (or alternatively, it can be left indefinitely). The growing assembly 4′ can be combined with growing assemblies 4′ of other SSTS 2′ and deployed to form a reef 400′. When combining with other SSTS's 2′, the growing assembly 4′ can be flexed to an enlarged state, e.g., unrolled, to enlarge the size of the reef 400′.

The SSTS 2 or SSTS 2′ can be deployed in situ at the actual target reef site at any stage of the method described above, including introduction of the larvae, removal of the nonpermeable protective layer 16, removal of the permeable protective layer 14, or forming modular reefs 400 and 400′. A reef, such as reef 400 or 400′ formed by one or more modules 402 or 402′, has robustness and stability. The shellfish attached thereto have been acclimated to the ambient environment from a very early stage, possibly even the pediveliger larvae stage, without being traumatized by relocation. Since the young shellfish are robust and acclimated to the ambient environment at an early stage of their development, the season for during which they can be introduced to SSTS 2 or SSTS 2′ for developing a reef 400 or 400′ can be extended.

The SSTS's 2 and 2′ are resilient to waves. By floating the SSTS's 2 or 2′, or perching them on a pedestal, the shellfish, young or mature, are safe from silt churned by waves that can smother them when they are deposited on the floor of a body of water. The shellfish are securely attached to the SSTS 2 or 2′ before the protective layer(s) are removed, and the shellfish are therefore not in danger of being scattered about by the waves. The SSTS 2 or 2′ can be anchored and floated by a floating device, having the ability to maneuver in rough water without damage to the shellfish or SSTS 2 or 2′ by waves. Joining the SSTS's 2 or 2′ in a modular formation adds integrity, and the stability of the individual SSTS's 2 or 2′ and the reef 400 or 400′ improves.

Experimentation was performed using an SSTS having a growing assembly configured similar the embodiment of growing assembly 4 shown in FIG. 2. On Jul. 8, 2012, 30,000 Eastern Oyster pediveliger larvae mixed with water were placed in the SSTS in a laboratory setting. The water that the larvae were mixed with was retrieved from a natural water body that the SSTS would soon be deployed, and filtered using a 50 micron filter. The SSTS was enveloped in a nonpermeable protective layer, such as layer 16 and placed in a tub holding water. The nonpermeable protective layer separated the larvae from the water in the tub.

On Jul. 10, 2012, the SSTS was removed from the tub of water and the nonpermeable protective layer was removed. The oyster larvae were observed to have successfully set within the SSTS. The SSTS was then enveloped (including bottom, sides, and top) with a permeable 4 mm mesh layer. The SSTS was placed in the natural water body from which the water used during attachment had been retrieved, and was tethered to a dock.

On Aug. 10, 2012, the portion of the mesh layer covering the top face of the SSTS was opened, and the contents of the SSTS were inspected. The diameter of the oysters was measured to be approximately 10-15 mm. Over thirty shrimp were discovered inside the SSTS. The mesh layer was replaced over the top face of the SSTS. The SSTS remained deployed in the natural body of water, tethered to the dock.

On Sep. 11, 2012, the 4 mm mesh layer was removed and the contents of the SSTS were inspected. The 4 mm mesh was removed. Approximately 4,000-5,000 oysters were observed inside the SST, measuring approximately 25 mm in diameter. Also, two immature fish, one oyster drill, and a blue claw crab were found inside the SSTS. The SSTS was then deployed in a different area of the same body of water, and anchored to a buoyed line that was secured across the body of water.

The SSTS was observed to be intact immediately following Hurricane Sandy, which made landfall on Oct. 29, 2012. The SSTS was still anchored to the buoyed line with a healthy oyster population growing inside.

It will be appreciated that the present disclosure has been described herein with reference to certain preferred or exemplary embodiments. The preferred or exemplary embodiments described herein may be modified, changed, added to or deviated from without departing from the intent, spirit and scope of the present disclosure, and it is intended that all such additions, modifications, amendments and/or deviations be included in the scope of the present disclosure.

1. A shellfish set trap system comprising:
a growing assembly that includes a material which is conducive for shellfish in the pediveliger larvae stage to attach themselves to; and
a first protective layer that substantially envelops at least a first portion of the growing assembly during a first developmental stage of the shellfish and is removed from the growing assembly after completion of the first developmental stage; and
a second protective layer that substantially envelops at least a second portion of the growing assembly during a second developmental stage of the shellfish, wherein the at least a second portion of the growing assembly is submerged in water during the second developmental stage of the shellfish.

2. The shellfish set trap system according to claim 1, wherein:
the first protective layer is a removable nonpermeable layer that provides a barrier between larvae provided in the growing assembly and the ambient environment; and
the second protective layer is a permeable layer.

3. (canceled)

4. The shellfish set trap system according to claim 1, wherein the second protective layer is provided with a temporary coupling so that the second protective layer will break along the temporary coupling in response to application of pressure to the second protective layer.

5. The shellfish set trap system according to claim 1, wherein the growing assembly includes at least one permeable structure and a plurality of growing elements mounted to the at least one permeable structure.

6. (canceled)

7. (canceled)

8. (canceled)

9. (canceled)

10. The shellfish set trap system according to claim 5, wherein the at least one permeable structure of the growing assembly includes a first and second permeable structure, and the plurality of growing elements are positioned between the first and second permeable structures in order to mount the plurality of growing elements between the first and second permeable structures.

11. (canceled)

12. The shellfish set trap system according to claim 1, wherein the second protective layer has a plurality of apertures sized to protect shellfish attached to the growing assembly from substantial predation during the second developmental stage.

13. The shellfish set trap system according to claim 1, wherein the growing assembly is flexed into a first shape while enveloped by the first or second protective layers, and the growing assembly is flexed into a second shape after the first and second protective layers are removed.

14. The shellfish set trap system according to claim 1, wherein the first protective layer forms a vessel that can hold a liquid, and the growing assembly is inserted into the vessel, wherein the growing assembly is disposed in the vessel during the first developmental stage and the first protective layer is removed by removing the growing assembly from the vessel.

15. (canceled)

16. The shellfish set trap system according to claim 14, wherein the first protective layer is wrapped around the growing assembly before it is inserted into the vessel.

17. The shellfish set trap system according to claim 1, wherein the second protective layer is wrapped around the growing assembly after the first protective layer is removed.

18. The shellfish set trap system according to claim 1, wherein a modular reef is formed by combining a first and second module, the first module including the growing assembly after the first protective layer is removed, and the second module including a second growing assembly of a second shellfish set trap system after its first protective layer is removed.

19. The shellfish set trap system according to claim 18, wherein the first and second modules are coupled to one another.

20. The shellfish set trap system according to claim 1, further comprising a flotation device attached to the growing assembly.

21. The shellfish set trap system according to claim 20, wherein the growing assembly includes an aperture that is positioned substantially above the water via which shellfish in the pediveliger larvae stage are introduced into the growing assembly.

22. The shellfish set trap system according to claim 20, further comprising an anchor coupled to the growing assembly.

23. The shellfish set trap system according to claim 1, wherein the shellfish set trap system is positioned on a pedestal that is positioned on the floor of a body of water.

24. The shellfish set trap system according to claim 1, wherein the growing assembly is expandable in at least one dimension after the first or second protective layers are removed.

25. The shellfish set trap system according to claim 5, wherein the at least one permanent structure is provided with at least two surfaces upon which the growing elements are mounted, wherein the at least two surfaces are movable relative to one other.

26. (canceled)

27. A method for developing a reef, the method comprising:
enveloping a growing assembly with a first protective layer, wherein the growing assembly includes a material which is favorable for shellfish in the pediveliger larvae stage to attach themselves to, wherein the first protective layer includes a nonpermeable layer that substantially envelops at least a first portion of the growing assembly during a first developmental stage of the shellfish so that the first protective layer provides a barrier between the first portion of the growing assembly and its ambient environment;
enveloping the growing assembly with a second protective layer so that the second protective layer substantially envelops at least a second portion of the growing assembly during a second developmental stage of the shellfish, wherein the second protective layer is a permeable layer;
introducing a plurality of shellfish in the pediveliger larvae stage and filtered water
into the growing assembly, subsequent to enveloping the growing assembly with the first protective layer;
deploying the growing assembly in situ, wherein at least the second portion of the growing assembly is submerged in water during at least the second developmental stage of the shellfish;
waiting a first time interval until the completion of the first developmental stage of the shellfish; and
subsequent to the waiting the first time interval, removing the at least one protective layer.

28. (canceled)

29. (canceled)

30. (canceled)

31. (canceled)

32. (canceled)

33. (canceled)

34. The method according to claim 27, wherein introducing the plurality of larvae into the vessel includes providing the plurality of larvae and filtered water into the vessel while the growing assembly is disposed in the vessel.

35. The method according to claim 26, wherein enveloping the growing assembly with the second protective layer is performed before enveloping the growing assembly with the first protective layer.

36. The method according to claim 26, wherein enveloping the growing assembly with the second protective layer is performed after enveloping the growing assembly with the first protective layer, and after the first protective layer is removed.

37. (canceled)

38. (canceled)

39. The method according to claim 26, wherein deploying the growing assembly in situ includes attaching a flotation device to the shellfish set trap system.

40. The method according to claim 26, wherein deploying the growing assembly in situ includes positioning the growing assembly on a pedestal that is positioned on the floor of a body of water.
